(19) United States
(12) Patent Application Publication
(10) Pub. No.: US 2009/0291310 A1
(43) Pub. Date: Nov. 26, 2009

(54) OPAL LATEX

(76) Inventors: Kenneth A. Fields II, Cincinnati, OH (US); Hai Hui Lin, Mason, OH (US); Philippe Schottland, West Chester, OH (US)

Correspondence Address: FROST BROWN TODD, LLC, 2200 PNC CENTER, 201 E. FIFTH STREET, CINCINNATI, OH, 45202, US

(21) Appl. No.: 12/125,742

(22) Filed: May 22, 2008

(51) Int. Cl. B32B 15/02

(52) U.S. Cl. 428/407

(57) ABSTRACT

A three-dimensional structure of monodispersed particles, wherein the particles are formed from an emulsion polymerization comprising both hydrophobic and hydrophilic monomers.

### BACKGROUND

Precious opals are well known for their striking color displays. The strong color effect by these natural gemstones typically originates from their unique structures formed by closely packed, uniformly sized silica spheres (Sanders J V, Nature 1964, 204, 1151-1153; Acta Crystallogr. 1968, 24, 427-434). These highly organized structures (super-lattices of silica spheres) with the size of the spheres in the range of wavelength of visible light selectively diffract certain wavelengths and, as a result, provide strong, angle dependent colors corresponding to the diffracted wavelengths.

Typically a coating with an opalescent color effect contains an inorganic opal pigment in a resin or latex binder system. Recently, opalescent color effects have been generated by core-shell monodispersed spheres, US 2006/0078736, and US 2004/0071965, where the core of the sphere is formed initially, followed by a second step to form the shell.

Color pigments with a periodic three-dimensional structure may yield color effects as a result of light diffraction by the ordered three-dimensional structures of monodispersed particles. The color effects may be optimized by adjusting the refractive index of the monodispersed particles, the size of the particles, and the media in between the particles.

In order to reproducibly make a consistent opalescent color effect, it is necessary to control the uniformity, size, and refractive index of the particles produced. In addition, for the purpose of a durable opalescent color effect, it is important to make a particle that is dimensionally stable. Consequently, a significant need exists for new polymeric particles that may form an opalescent color effect.

### BRIEF SUMMARY

The above-noted and other deficiencies may be overcome by providing a polymeric particle, wherein the polymeric particle is formed by an emulsion polymerization of one or more hydrophobic monomer, one or more hydrophilic monomer, and one or more cross-linker; wherein at least one hydrophobic monomer and at least one hydrophilic monomer are mixed prior to initiation of polymerization.

One embodiment is a polymeric particle, wherein the polymeric particle is formed by an emulsion polymerization of one or more hydrophobic monomer, one or more hydrophilic monomer, and one or more cross-linker; wherein at least one hydrophobic monomer and at least one hydrophilic monomer are mixed prior to initiation of polymerization.

Another embodiment is a method of making a polymeric particle, comprising the steps of mixing one or more hydrophobic monomer, one or more hydrophilic monomer, and one or more cross-linker, in a solvent; and initiating an emulsion polymerization.

Another embodiment is a method for making an opal latex, where the three-dimensional periodic structure of the polymeric particles in the opal latex reproducibly has the same opalescent color.

Another embodiment is a polymeric particle formed by an emulsion polymerization that reproducibly results in a particle size from about 200 nm to about 290 nm, where multiple particles form a three-dimensional periodic structure with a blue green opalescent color.

Another embodiment is a polymeric particle formed by an emulsion polymerization that reproducibly results in a particle size from about 400 nm to about 580 nm, where multiple particles form a three-dimensional periodic structure with a violet opalescent color.

These and other objects and advantages shall be made apparent from the accompanying drawings and the description thereof.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is a transmission electron microscope photograph of opal latex made as described in Example 1.

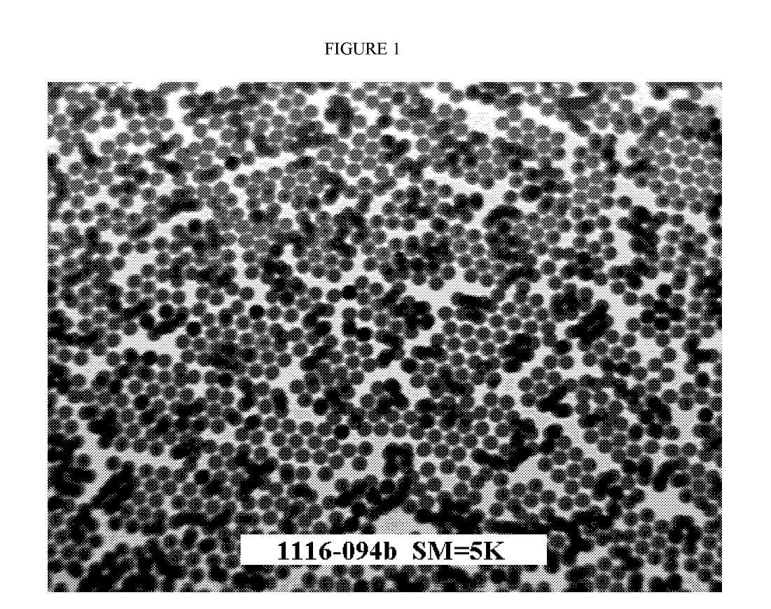

### DETAILED DESCRIPTION

One embodiment of a polymeric particle is a polymeric particle formed by an emulsion polymerization of one or more hydrophobic monomer, one or more hydrophilic monomer, and one or more cross-linker; wherein at least one hydrophobic monomer and at least one hydrophilic monomer are mixed prior to initiation of polymerization.

A hydrophobic monomer is a monomer that when placed into water does not substantially dissolves in water. Typically, a hydrophobic monomer will form a separate phase in an aqueous solution. An aqueous solution of hydrophobic monomer may be agitated to form an emulsion, or an emulsion may be formed by an emulsifying agent such as a soap or detergent. Examples of hydrophobic monomers are monovinyl aromatic hydrocarbons such as styrene, 4-methoxystyrene, α-methylstyrene, vinyltoluene, α-chlorostyrene, o-, m- or p-chlorostyrene, p-ethylstyrene, and vinylnaphthalene; and acrylic monomers such as methacrylic acid, methyl acrylate, ethyl acrylate, butyl acrylate, 2-ethylhexyl acrylate, cyclohexyl acrylate, phenyl acrylate, methacrylic acid, methyl methacrylate, ethyl methacrylate, propyl methacrylate, butyl methacrylate, hexyl methacrylate and 2-ethylhexyl methacrylate, or copolymers of two or more different monomers. In one embodiment, at least one hydrophobic monomer is methyl methacrylate.

A hydrophilic monomer is a monomer that when placed into water substantially dissolves in water. Typically, a hydrophilic monomer will not form a separate phase in an aqueous solution. Examples of hydrophilic monomers are N-alkyl acrylamide and N-aryl acrylamide, such as N-methylacrylamide, N-ethylacrylamide, N-cyclopropylacrylamide, N-isopropylacrylamide, N-methylmethacrylamide, N-cyclopropylmethacrylamide, N-isopropylmethacrylamide, N-acryloyl pyrrolidone, N-acryloylpiperidone, N-acryloylmethylhomopiperazine and N-acryloylmethylpiperazine, N-phenyl acrylamide; N-alkyl-N-alkyl acrylamide, such as N,N-dimethylacrylamide, N-methyl-N-ethylacrylamide, N-methyl-N-isopropylacrylamide, N-methyl-N-n-propylacrylamide, N,N-diethylacrylamide, N-ethyl-N-isopropylacrylamide, N-ethyl-N-n-propylacrylamide, N,N-diisopropylacrylamide; alkylacrylamide such as methacrylamide; and monomers comprising a charged or polar functional group such as a carboxylic acid, amine, or amide, such as acrylic acid, methacrylamide-propyl-trimethyl-ammoniumchloride, 1-vinylimidazole and methacryloyloxyphenyldimethylsulfonium methylsulfate. In one embodiment, at least one hydrophilic monomer is N-isopropylacrylamide.

The polymers inside the polymeric particle may be linked by a crosslinking agent. Crosslinks between the polymers inside the polymeric particle will impart structural stability to the particle. Crosslinking agents are typically monomers with two or more sites of reactivity, that may react with two or more polymer chains during or after polymerization. An example of a crosslinking agent is a diene, such as: N,N′-methylene-bis-acrylamide (MBAAm), allyl metharcrylate (AMA), and ethylene glycol dimethacrylate. Crosslinking agents are conventionally known, and one of ordinary skill would be able to choose an appropriate crosslinking agent.

Crosslinking agents may be classified as hydrophobic or hydrophilic, in the same way that monomers may be classified as hydrophobic or hydrophilic. Examples of hydrophobic cross-linkers are allyl methacrylate, and other hydrophobic monomers comprising at least two double bonds. Example of a hydrophilic cross-linkers are N,N′-methylene-bis-acrylamide, N-alkyl acrylamide, N-alkyl-N-alkyl acrylamide, and acrylamide; provided that the cross-linker comprises at least two double bonds.

The mole ratios of the hydrophobic and hydrophilic monomers, and the hydrophobic and hydrophilic crosslinkers may effect the size, density, and index of refraction of the polymeric particles. These changes to the particles may alter the three-dimensional periodic structure of the polymeric particles, and consequently alter the color produced. In general, polymeric particles with a higher ratio of crosslinkers to monomers will have a smaller size, and the color will be a shorter wavelength. In one embodiment, the mole ratio of hydrophobic monomer to hydrophobic crosslinker is from about 30:1 to about 3:1; from about 25:1 to about 4:1; or from about 20:1 to about 6:1. In one embodiment, the mole ratio of hydrophilic monomer to hydrophilic crosslinker is from about 30:1 to about 3:1, from about 25:1 to about 4:1, or from about 20:1 to about 6:1.

The mole ratio of hydrophobic and hydrophilic monomers may also effect the color produced by the polymeric particles. In one embodiment, the mole ratio of hydrophobic monomer to hydrophilic monomer is from about 30:1 to about 2:1, from about 15:1 to about 3:1, or from about 30:1 to about 15:1.

The mole ratio of initiator to monomer may also effect the color produced by the polymeric particles. In one embodiment, the mole ratio of the initiator to monomer is from about 1:1000 to about 1:50, or from about 1:200 to about 1:75.

In one embodiment the polymeric particles are from about 200 nm to about 600 nm in diameter. The diameter of the particles may be from about 200 nm to about 290 nm, or from 280 nm to about 300 nm. The ranges may be ±10 nm. The diameter of the particles may be from about 400 nm to about 580 nm. The range may be ±20 nm. The particles may be approximately spherical in shape, or they may be oblate spheroid. The surface of the particles may be smooth, or it may contain bumps or indentations.

Emulsion polymerizations typically use water as a solvent. However, it is possible to use organic solvents for an inverse or water-in-oil emulsion polymerization.

Additives may be added before, during, or after, the emulsion polymerization to modify the properties of the polymeric particle. An example of an additive is a monomer that will add polar groups, or reactive functionality to the particle surface. Examples of reactive functionality are carboxylic acids, alcohols, thiols, and amines. Examples of additives are metharcrylic acid, 2-hydroxy ethylmethacrylate, 2-hydroxy acrylate, PEG methyl ether acrylate, and acrylic acid. In one embodiment additives are added when the polymerization is almost completed.

The polymeric particles are useful as a colorant. They may be used in an ink formulation. In one embodiment the ink comprises a binder. Examples of a binder are polyvinyl butyral (PVB), polyurethane dispersion (PUD), poly-2-ethylhexyl acrylate, and high energy curable monomers. Examples of high energy curable monomers are solvent soluble mono-, and di-functional, acrylates, cycloaliphatic epoxides, and oxitanes; with viscosity less than 1000 cp, shrinkage range of 10 to 35% and a photoinitiator loading of 4 to 6%. The viscosity may be 500 to 800 cp, or less than 500 cp.

Laying down a thin urethane film on a substrate before the application of an ink formulation will provide a smooth surface for the ink to be applied, allowing for the optimum alignment of the particles.

The polymeric particles may aggregate to form a three-dimensional periodic structure. The polymeric particles may be linked together so they maintain the three-dimensional periodic structure. The particles may be linked by reacting with reactive functionality on the particle surface. An example of a linking agent is an epoxysilane linker, or high energy curable monomers. The curable monomers may not chemically bond the particles together, but may physically aggregate the particles by forming a film around the particles during polymerization.

While the present description of several embodiments have been illustrated in considerable detail, it is not the intention of the applicant to limit the scope of the claims to such detail. Additional advantages and modifications may readily appear to those skilled in the art.

### COMPARATIVE EXAMPLE 1

### Synthesis of Core-Shell PS-PNIPAAm Opal Latex

### PS-PNIPAAm Reactant Composition Table

| Name | Mole | Mass | |
|---|---|---|---|
| Styrene (S, core monomer) | 0.197 | 20.49 | g |
| n-isopropylacrylamide (NIPAAm, | 2.66E−02 | 3.0 | g |
| shell monomer) | 3.72E−02 | 4.2 | g |
| N,N′-methylene-bis-acrylamide | 2.7E−03 | 0.42 | g |
| (MBAAm, shell cross linker) | | | |
| Ammonium persulfate, | 1.14E−03 | 0.26 | g |
| ((NH₄)₂S₂O₈, initator) | 3.8E−04 | 0.086 | g |
| Water | 44.4 | (600 + 200 | g) |

Core formation: A cylindrical 1 L vessel fitted with a helium purging line and a vertical frame stir blade, was charged with n-isoproprylacrylamide (3.0 g), and DI water (580 g), and heated to 70° C. Stirring was set to 300 RPM. Styrene (20.49 g) was added drop-wise to the vessel, and residual monomer was washed into the vessel with DI water (10 g). The mixture was stirred at 300 RPM for 30 minutes, and the atmosphere was purged to remove oxygen.

Initiator Addition: Ammonium persulfate (0.26 g) in DI water (10 g) was added drop-wise into the reaction vessel. The mixture was stirred for 4 hours at 300 RPM, at 70° C. to form the core.

Shell formation: n-isoproprylacrylamide (4.2 g) and N,N′-methylene-bisacrylamide (0.42 g) in DI water (100 g) was added to the mixture all at once, and follow by DI water (90 g). After the mixture was stirred for 30 minutes at 300 RPM, at 70° C., ammonium persulfate (0.086 g) in DI water (10 g) was added to the mixture.

After 2 hours the mixture was ultracentrifuged at 12,000 RPM, and the supernatant aliquot was removed. The latex was slurried in ethanol and centrifuged again. The ethanol wash was repeated twice.

The latex was used to create an ink with a pigment loading between 30-45%. The ink may be formed by any of the procedures shown in examples 6, 7, or 8.

### EXAMPLE 2

### Simultaneous Polymerization Synthesis of PS-PNIPAAm Opal Latex

### PS-PNIPAAm Reactant Composition Chart

| Name | Mole | Mass | |
|---|---|---|---|
| Styrene (S, core monomer) | 0.197 | 16.8 | g |
| n-isopropylacrylamide | 2.66E−02 | 1.5 | g |
| (NIPAAm, shell monomer) | 3.72E−02 | 4.2 | g |
| N,N′-methylene-bis-acrylamide | 2.7E−03 | 0.42 | g |
| (MBAAm, shell crosslinker) | | | |
| Ammonium persulfate, | 2.28E−03 | 0.520 | g |
| ((NH₄)₂S₂O₈, initator) | 3.8E−04 | 0.087 | g |
| Water | 44.4 | (600 + 200 | g) |

Polymer particle formation: A cylindrical 1 L vessel fitted with a helium purging line and a vertical frame stir blade, was charged with n-isoproprylacrylamide (5.7 g), and DI water (580 g), and heated to 70° C. Stirring was set to 275 RPM. Styrene (16.8 g) was added drop-wise to the vessel, and residual monomer was washed into the vessel with DI water (10 g). The mixture was stirred at 275 RPM for 20 minutes, and the atmosphere was purged to remove oxygen.

Initiator Addition: ammonium persulfate (0.52 g) in DI water (10 g) was added drop-wise into the reaction vessel. The mixture was stirred for 5 hours at 275 RPM, at 70° C.

Crosslinker Addition: N-methylene-bisacrylamide (0.42 g) in DI water (100 g) was sonicated for 10 minutes, then added to the mixture all at once, followed by DI water (90 g).

After 3.5 hours the mixture was ultracentrifuged at 12,000 RPM, and the supernatant aliquot was removed. The latex was slurried in ethanol and centrifuged again. The ethanol wash was repeated twice.

The latex was used to create an ink with a pigment loading between 30-45%. The ink may be formed by any of the procedures shown in examples 6, 7, or 8.

### COMPARATIVE EXAMPLE 3

### Synthesis of Core-Shell PMMA-PNIPAAm Opal Latex

### PMMA-PNIPAAm Reactant Composition Chart

| Name | Mole | Mass | |
|---|---|---|---|
| Methylmethacrylate (MMA, | 0.197 | 19.7 | g |
| core monomer) | | | |
| n-isopropylacrylamide | 2.66E−02 | 3.0 | g |
| (NIPAAm, shell monomer) | 3.72E−02 | 4.2 | g |
| N,N′-methylene-bis-acrylamide | 2.7E−03 | 0.42 | g |
| (MBAAm, shell crosslinker) | | | |
| Ammonium persulfate, | 1.14E−03 | 0.260 | g |
| ((NH₄)₂S₂O₈, initator) | 3.8E−04 | 0.087 | g |
| Water | 44.4 | (600 + 200 | g) |

Reactor Setup: Use a cylindrical 1 L (4″ ID) vessel in oil-heated vessel with a helium purging line just below water-line. The blade is a vertical frame blade to ensure uniform radial flow and gentle stir. This is to minimize latex collision which leads aggregation and wide spread poly-dispersity (PD). Set bath temperature at 70° C. and gas pressure at secondary valve is set at 10 Psi. The bubble-line is control by a needle valve. It should take ˜20 minutes for bath to warm up.

NIPAAm Solution Preparation: Weigh 580 g DI water and charge into 1 L cylindrical vessel. Set agitation speed at 300 RPM. Start bubbling helium through, just below the water line. Wait 20 minutes to allow for oxygen removal and heat up of water to 70° C. Add 3.0 g of n-isoproprylacrylamide (NIPAAm) monomer through addition hole using a funnel. The solid should dissolve within a couple minutes.

Styrene Emulsion Formation: Weigh 19.7 g Methylmethacrylate (MMA) monomer into a glass scintillation vial and then add drop-wise into reaction vessel. Rinse the residual monomer into vessel with 10 g DI water. A translucent emulsion should form. Stir at 300 RPM for 20 minutes to allow for complete homogenization of styrene oil droplets in water. The agitation speed should be enough to suck droplets all the way down to the bottom. The droplet is typically 0.1-1 mm in size (visible). If styrene is still predominantly floating on top, increase the agitation accordingly.

1^{st} APS Initiator Addition: Weigh 0.26 g ammonium persulfate ((NH₄)₂S₂O₈) into a scintillation vial and then add 10 g DI water to dissolve it and sonicate it to remove oxygen. Add the initiator solution drop-wise into the reaction vessel.

Core Formation: Let reaction go at 70° C. for 5 hour at 300 RPM. At the end of reaction, stop the agitation, and see if there is any styrene oil droplet float to the top. If yes, continue until no oil droplet is observed

2^{nd} NIPAAm-Crosslinker Addition: Upon core formation, weigh 100 g DI water in a 8 oz jar with magnetic stir; add 4.2 g of n-isoproprylacrylamide (NIPAAm) monomer and then 0.42 of n-n-methylene-bisacrylamide (MBAAm, crosslinker) and let dissolve. Upon dissolution, sonicate it for 10 minutes and then charge the solution into the reaction vessel all once, and follow by another 90 g DI water to make solution volume of 800 ml. Keep agitation at 300 RPM and let stir for 20 minutes to remove oxygen brought by the new water.

Shell Formation: Dissolve 0.087 g ammonium persulfate in 10 g DI water and sonicate it and then charge into the reaction vessel. Keep temperature at 70° C. and let go for another 3 hour to complete shell formation

The mixture was ultracentrifuged at 12,000 RPM, and the supernatant aliquot was removed. The latex was slurried in ethanol and centrifuged again. The ethanol wash was repeated twice.

### EXAMPLE 4

### Simultaneous Polymerization Synthesis of PMMA-PNIPAAm Opal Latex

### PMMA-PNIPAAm Reactant Composition Chart

| | | | Mass | |
|---|---|---|---|---|
| Name | % Mass | Mole | (g) | |
| Methylmethacrylate (MMA, core | 7% | 0.44 | 43.96 | |
| monomer) | | | | |
| Allyl Methacrylate (AMA, core | 0.7% | 3.48E−02 | 4.39 | |
| crosslinker) | | | | |
| Water (coolant & outer phase) | 92.4% | 32.2 | 580.4 | |
| 2,2′-Azobis(2- | 0.1% | 1.85E−03 | 0.5 | |
| methylpropionamidine) | | | | |
| dihydrochloride (AMPAm) | | | | |
| n-isopropylacrylamide | — | 0.0265 | 3.0 | |
| (NIPAAm, shell monomer) | | | | |
| N,N′-methylene-bis-acrylamide | — | 1.95E−03 | 0.45 | |
| (MBAAm, shell crosslinker) | | | | |
| Water | — | — | 59.4 | |
| Total | 100% + | | 692.12 | g |
| | 10% | | | |

Intended color - violet

A cylindrical 1 L vessel (6.5″ high, 4″ ID) fitted with a helium purging line and a 2″ anchor U blade, was charged with methylmethacrylate (5.7 g), allyl methacrylate (4.39 g), and DI water (582.4 g), and heated to 75° C. Stirring was set to 250 RPM. Then n-isoproprylacrylamide (3.0 g), and N,N′-methylene-bisacrylamide (0.45 g) in DI water (59.4 g) was added to the mixture. The mixture was stirred at 250 RPM for 15 minutes, and the atmosphere was purged to remove oxygen.

Initiator Addition: 2,2′-Azobis(2-methylpropionamidine) dihydrochloride (0.5 g) in DI water (15 g) was sonicated at room temperature for 5 minutes, then added drop-wise into the reaction vessel. The mixture was stirred for 4.5 hours at 250 RPM, at 75° C.

The latex solution was then filtered through a funnel, lightly packed with glass wool, to remove any chunks and scale, twice.

### COMPARATIVE EXAMPLE 5

### Synthesis of Core-Shell PMMA-PNIPAAm Opal Latex With Surface Functionalization

### PMMA-PNIPAAm Reactant Composition Chart

| | | | Mass |
|---|---|---|---|
| Name | % Mass | Mole | (g) |
| Methylmethacrylate (MMA, core | 7% | 0.44 | 43.96 |
| monomer) | | | |
| Allyl Methacrylate (AMA, core | 0.175% | 8.73E−03 | 1.1 |
| crosslinker | | | |
| Water (coolant & outer phase) | 92.4% | 32.2 | 580.4 |
| 2,2′-Azobis(2- | 0.1% | 1.85E−03 | 0.5 |
| methylpropionamidine) | | | |
| dihydrochloride (AMPAm) | | | |
| n-isopropylacrylamide | — | 0.0265 | 3.0 |
| (NIPAAm, shell monomer) | | | |
| N,N′-methylene-bis-acrylamide | — | 1.95E−03 | 0.30 |
| (MBAAm, shell crosslinker) | | | |
| Water | — | — | 59.4 |
| Methacrylic Acid | — | 1.04E−03 | 0.075 |
| (MAAc, anionic Co-monomer) | | | |
| Total | 100% + 10% | | 628 g + |
| | | | 62.8 g |

Core formation: A cylindrical vessel fitted with a helium purging line and a stir blade, was charged with methylmethacrylate (43.96 g), and allyl methacrylate (1.1 g), and DI water (582.4 g), and heated to 75° C. The mixture was stirred at 250 RPM for 15 minutes, and the atmosphere was purged to remove oxygen.

Initiator Addition: 2,2′-Azobis(2-methylpropionamidine) dihydrochloride (0.5 g) in DI water (15 g) was sonicated at room temperature for 5 minutes, then added drop-wise into the reaction vessel. The mixture was stirred for 1.5 hours.

Shell formation: the stirring was decreased to 100 RPM, and n-isoproprylacrylamide (3.0 g), N,N′-methylene-bisacrylamide (0.30 g), and methacrylic acid (1.0 g of 7.5% wt in DI water) in DI water (59.4 g) was added to the mixture all at once, and follow by DI water (90 g). Stirring was continued for a total of 3 hours.

The mixture was ultracentrifuged at 12,000 RPM, and the supernatant aliquot was removed. The latex was slurried in ethanol and centrifuged again. The ethanol wash was repeated twice.

### EXAMPLE 6

### Opal Latex Laid-Down Method Using PVB

Opal latex was ultracentrifuged in a TEFLON tube at 12,000 RPM, and the supernatant aliquot was removed. The latex was slurried in water and centrifuged. The water wash was repeated twice. The latex was slurried in ethanol and centrifuged. The ethanol wash was repeated twice.

The dry content of the latex was adjusted to 45% wt latex by adding ethanol followed by mixing using a Hauschild mixer to generate a soft latex paste. PVB (0.1 g) was added to the latex followed by mixing with a Hayschild mixer.

The latex (0.2 g) was laid-down with draw down rods (#5. #6, #7, #8, #9, #10, #11, #12, #13, #14, #15, #16, #17, #18, #19, #20, #22, #24, #26, #28, #30, #32, #34, #36, #38, #40) and blade coater with gap settings (1-50)

### EXAMPLE 7

### Opal Latex Laid-Down Method Using PUD

Opal latex was mixed with PUD (CP 1003, CP 1011, CP 1012, CP 1015, CP 1016, CP 7020, CP 7030, WLS 201, WLS 202, WLS 210, WLS 213) at percentage (0.1%-0.5%). Then mixed in a Hauschild mixer.

The mixture (2 g) was place into a Petri dish (glass, polystyrene) and heated in an oven at 80 degrees for 10 minutes.

### EXAMPLE 8

### Opal Latex Laid-Down Method Using Epoxyilane Crosslinker

Mix opal latex with an epoxy silane solution (0.1 g of 40% wt (3,4-epoxycyclohexyl)ethyltriethoxysilane) using a Hauschild mixer at 3000 RPM for 4 minutes in a 4 oz poly-propylene container.

### EXAMPLE 9

### Opal Latex Laid-Down Method using Poly-2-ethylhexyl acrylate

A latex binder mixture was prepared by mixing latex powder (30%), poly-2-ethylhexyl acrylate (10%), and ethanol (60%) in a Hauschild mixer at 3000 RPM for 3 minutes in a 4 oz poly-propylene container.

### COMPARATIVE EXAMPLE 10

### Synthesis of Core-Shell PS-PNIPAAm Opal Latex

### PS-PNIPAAm Reactant Composition Chart

| Name | Mole | Mass | |
|---|---|---|---|
| Styrene (S, core monomer) | 0.197 | 20.49 | g |
| n-isopropylacrylamide | 2.66E−02 | 3.0 | g |
| (NIPAAm, shell monomer) | 3.72E−02 | 4.2 | g |
| N,N′-methylene-bis-acrylamide | 2.7E−03 | 0.42 | g |
| (MBAAm, shell crosslinker) | | | |
| Ammonium persulfate, | 2.28E−03 | 0.52 | g |
| ((NH₄)₂S₂O₈, initator) | 3.8E−04 | 0.087 | g |
| N,N,N′,N′,- | N/A | N/A | |
| tetramethylethylenediamine | N/A | N/A | |
| (TEMED, co-initiaor) | | | |
| Water | 44.4 | (600 + 200 | g) |

Core-shell PS-PNIPAAm opal latex was formed as in Example 1 except the stirring rate was 250 RPM, and 0.52 g of ammonium persulfate was used for the first reaction initiation, and 0.087 was used in the second reaction initiation.

### COMPARATIVE EXAMPLE 11

### Synthesis of Core-Shell PS-PNIPAAm Opal Latex

### PS-PNIPAAm Reactant Composition Chart

| Name | Mole | Mass | |
|---|---|---|---|
| Styrene (S, core monomer) | 0.1576 | 16.39 | |
| n-isopropylacrylamide | 2.66E−02 | 3.0 | g |
| (NIPAAm, shell monomer) | 3.72E−02 | 4.2 | g |
| N,N′-methylene-bis-acrylamide | 2.7E−03 | 0.42 | g |
| (MBAAm, shell crosslinker) | | | |
| Ammonium persulfate, | 2.28E−03 | 0.520 | g |
| ((NH₄)₂S₂O₈, initator) | 3.8E−04 | 0.087 | g |
| N,N,N′,N′,- | N/A | N/A | |
| tetramethylethylenediamine | N/A | N/A | |
| (TEMED, co-initiaor) | | | |
| Water | 44.4 | (600 + 200 | g) |

Core-shell PS-PNIPAAm opal latex was formed as in Example 10 except the amounts of styrene used was 16.39 g, the core formation was allowed to proceed for 6 hours, and the shell formation was allowed to proceed for 3 hours.

### COMPARATIVE EXAMPLE 12

### Synthesis of Core-Shell PS-PNIPAAm Opal Latex

### PS-PNIPAAm Reactant Composition Chart

| Name | Mole | Mass | |
|---|---|---|---|
| Styrene (S, core monomer) | 0.197 | 16.8 | g |
| n-isopropylacrylamide | 2.66E−02 | 1.9 | g |
| (NIPAAm, shell monomer) | 3.72E−02 | 4.2 | g |
| N,N′-methylene-bis-acrylamide | 2.7E−03 | 0.42 | g |
| (MBAAm, shell crosslinker) | | | |
| Ammonium persulfate, | 2.28E−03 | 0.520 | g |
| ((NH₄)₂S₂O₈, initator) | 3.8E−04 | 0.087 | g |
| N,N,N′,N′,- | N/A | N/A | |
| tetramethylethylenediamine | N/A | N/A | |
| (TEMED, co-initiaor) | | | |
| Water | 44.4 | (600 + 200 | g) |

Core-shell PS-PNIPAAm opal latex was formed as in Example 10 except the amounts of styrene used was 16.8 g, the amount of n-isopropylacrylamide was 1.9 g, the stirring rate was 275 RPM, and the core formation was allowed to proceed for 5 hours.

### EXAMPLE 13

### Simultaneous Polymerization Synthesis of MMA-NIPPAm Opal Latex

### MMA-PMMA Reactant Composition Chart

| | | | Mass |
|---|---|---|---|
| Name | % Mass | Mole | (g) |
| Methylmethacrylate | 7% | 0.44 | 43.96 |
| (MMA, core monomer) | | | |
| Allyl Methacrylate (AMA, | 0.7% | 3.48E−02 | 4.396 |
| core crosslinker) | | | |
| Water (coolant & outer | 92.4% | 32.2 | 580.4 |
| phase) | | | |
| 2,2′-Azobis(2- | 0.1% | 1.85E−03 | 0.5 |
| methylpropionamidine) | | | |
| dihydrochloride (AMPAm) | | | |
| n-isopropylacrylamide | — | 0.0265 | 3.0 |
| (NIPAAm, shell monomer) | | | |
| N,N′-methylene-bis- | — | 1.95E−03 | 0.45 |
| acrylamide (MBAAm, | | | |
| shell crosslinker) | | | |
| Water | — | — | 59.4 |
| Total | 100% + 10% | | 628 g + 62.8 g |

MMA-PNIPAAm opal latex was formed as in Example 4 except the stirring rate was 290 RPM.

Examples 10, 11, 12, and 13 were repeated multiple times. The film created by the beads was the color indicated in the table below. The films of examples 10, 11, and 12 did not reproducibly produce the same color.

| Repeat | Example 10 | Example 11 | Example 12 | Example 13 |
|---|---|---|---|---|
| 1 | No color | Blue | Blue | Violet |
| 2 | Green | Red | Violet | Violet |
| 3 | Green | Green | Green | Violet |
| 4 | Red | Violet | Green | |
| 5 | Green | Green | Violet | |
| 6 | Violet | No Color | Green | |
| 7 | | | Violet | |
| 8 | | | Blue | |
| 9 | | | Violet | |
| 10 | | | Green | |

### EXAMPLE 14

### Ink Formulation for Gravure Printing

Ink was formed by mixing opal latex (45%), ethanol (54%), and Poly(-2-ethyl-hexyl-acrylate) (1%) using a Hausechild mixer at 5000 RPM for 4 minutes.

Paper was locked in place under the roller of a Saueressing Colour Proofer. A cotton ball was placed at each end of the doctor blade to prevent run out. The ink (1 g) was place on the doctor blade and run.

### EXAMPLE 15

### Ink Formulation for Spray Coating

Ink was formed by mixing opal latex (1.0%), propanol (98.97%), and PVB B-73 (0.03%) in a Hausechild mixer at 5000 rpm for 4 minutes.

A spray gun was loaded with the pigment and sprayed onto a substrate.

Abbreviations: polystyrene (PS), poly-n-isopropylacrylamide (PNIPAAm), poly-methylmethacrylate (PMA).

What is claimed is:

1. A polymeric particle formed by an emulsion polymerization of one or more hydrophobic monomer, one or more hydrophilic monomer, and one or more cross-linker; wherein at least one hydrophobic monomer and at least one hydrophilic monomer are mixed prior to initiation of polymerization.

2. The polymeric particle of claim 1, wherein at least one hydrophobic monomer is selected from the group consisting of substituted styrene, unsubstituted styrene, alkyl methacrylate, and methacrylic acid.

3. The polymeric particle of claim 1, wherein at least one hydrophilic monomer is selected from the group consisting of N-alkyl acrylamide, N-alkyl-N-alkyl acrylamide, and acrylamide.

4. The polymeric particle of claim 1, wherein one or more cross-linker is a hydrophobic cross-linker and one or more cross-linker is a hydrophilic cross linker.

5. The polymeric particle of claim 4, wherein one or more hydrophobic cross-linker is selected from the group consisting of allyl methacrylate, substituted or unsubstituted styrene, alkyl methacrylate, and methacrylic acid; provided that the cross-linker comprises at least two double bonds.

6. The polymeric particle of claim 1, wherein the mole ratio of hydrophobic monomer to hydrophilic monomer is from about 30:1 to about 2:1.

7. The polymeric particle of claim 1, wherein the mole ratio of hydrophobic monomer to hydrophobic cross-linker is from about 30:1 to about 3:1.

8. The polymeric particle of claim 1, wherein the mole ratio of hydrophilic monomer to hydrophilic cross-linker is from about 30:1 to about 3:1.

9. The polymeric particle of claim 1, further comprising an initiator, wherein the mole ratio of initiator to monomer is from about 1:1000 to about 1:50.

10. The polymeric particle of claim 1, wherein the polymeric particles are about 200 nm to about 600 nm in diameter.

11. The polymeric particle of claim 1, wherein the solvent for the emulsion polymerization is water.

12. The polymeric particle of claim 1, wherein the surface of the polymeric particle comprise reactive functionality.

13. A colorant comprising the polymeric particles of claim 1.

14. An ink formulation, comprising the polymeric particles of claim 1.

15. The ink formulation of claim 14, wherein the binder portion of the ink is selected from the group consisting of polyvinyl butyral (PVB), polyurethane dispersion (PUD), poly-2-ethylhexyl acrylate, and high energy curable monomers.

16. A three-dimensional periodic structure, comprising the polymeric particles of claim 1.

17. An ink formulation, comprising the three-dimensional periodic structure of claim 16.

18. A printed article comprising the polymeric particles of claim 1.

19. The three-dimensional periodic structure of claim 16, wherein the polymeric particles are cross-linked by an epoxysilane linker or a high energy curable monomer.

20. The three-dimensional periodic structure of claim 16, further comprising mixing the three-dimensional periodic structure into a latex binder.

21. The three-dimensional periodic structure of claim 20, wherein the latex binder is selected from the group consisting of polyvinyl butyral (PVB), polyurethane dispersion (PUD), poly-2-ethylhexyl acrylate, and a high energy curable monomer.

22. A method of making a polymeric particle, comprising the steps of:
a) mixing one or more hydrophobic monomer, one or more hydrophilic monomer, and one or more cross-linker, in a solvent; and
b) initiating an emulsion polymerization.

23. The method of making the polymeric particle of claim 22, wherein at least one hydrophobic monomer is selected from the group consisting of substituted styrene, unsubstituted styrene, alkyl methacrylate, and methacrylic acid.

24. The method of making the polymeric particle of claim 22, wherein at least one hydrophilic monomer is selected from the group consisting of N-alkyl acrylamide, N-alkyl-N-alkyl acrylamide, and acrylamide.

25. The method of making the polymeric particle of claim 22, wherein one or more cross-linker is a hydrophobic cross-linker and one or more cross-linker is a hydrophilic cross linker.

26. The method of making the polymeric particle of claim 25, wherein one or more hydrophobic cross-linker is selected from the group consisting of allyl methacrylate, substituted or unsubstituted styrene, alkyl methacrylate, and methacrylic acid; provided that the cross-linker comprises at least two double bonds.

27. The method of making the polymeric particle of claim 25, wherein one or more hydrophilic cross-linker is selected from the group consisting of N,N′-methylene-bis-acrylamide, N-alkyl acrylamide, N-alkyl-N-alkyl acrylamide, and acrylamide; provided that the cross-linker comprises at least two double bonds.

28. A method of making a colorant, comprising the steps of claim 22 and further comprising the step of forming a three-dimensional periodic structure.

29. A method for making an opal latex, where the three-dimensional periodic structure of the polymeric particles in the opal latex reproducibly has the same opalescent color.

30. A polymeric particle formed by an emulsion polymerization that reproducibly results in a particle size from about 200 nm to about 290 nm, where multiple particles form a three-dimensional periodic structure with a blue green opalescent color.

31. A polymeric particle formed by an emulsion polymerization that reproducibly results in a particle size from about 400 nm to about 580 nm, where multiple particles form a three-dimensional periodic structure with a violet opalescent color.
